(19) United States
(12) Patent Application Publication
(10) Pub. No.: US 2017/0010386 A1
(43) Pub. Date: Jan. 12, 2017

(54) APPARATUS AND METHOD FOR DETECTING OBJECT WITHIN SHORT RANGE, AND VEHICLE USING THE SAME

(71) Applicants: Hyundai Motor Company, Seoul (KR); University Industry Foundation, Yousei University, Seoul (KR); Kia Motors Corporation, Seoul (KR)

(72) Inventors: Unkyu Park, Seoul (KR); Junwoo Park, Seoul (KR); Jaehyun Soh, Seoul (KR); Seungbae Son, Seoul (KR); Daeeun Kim, Seoul (KR); Changmin Lee, Seoul (KR)

(21) Appl. No.: 14/957,055

(22) Filed: Dec. 2, 2015

(30) Foreign Application Priority Data
Jul. 8, 2015 (KR) 10-2015-0097140

(51) Int. Cl. G01V 8/20; B60K 35/00

(52) U.S. Cl. CPC G01V 8/20; B60K 35/00

(57) ABSTRACT

An apparatus and method for detecting a short-range object, and a vehicle with such a detecting apparatus are provided. The apparatus includes a light transmitter that is configured to emit brightness-modulated light to an object and a light receiver that is configured to acquire a plurality of reflected image frames reflected from the object. A processor is then configured to extract a short-range object by analyzing brightness change of at least one of the plurality of reflected image frames.

### CROSS-REFERENCE TO RELATED APPLICATION

This application claims the benefit of Korean Patent Application No. 10-2015-0097140, filed on Jul. 08, 2015 in the Korean Intellectual Property Office, the disclosure of which is incorporated herein by reference.

### BACKGROUND

1. Field

The present invention relates to an apparatus and method for detecting an object within a short range, and a vehicle using the same, and more particularly relates to an apparatus and method for detecting a short-range object by emitting modulated infrared light to the object.

2. Description of the Related Art

Generally, a conventional method for detecting an object correctly detects on/off time points of an infrared light emitting diode (LED) using an imaging device (e.g., a camera, video camera, or the like), operates the imaging device to sequentially capture the object based on the on/off time points, and thus acquires infrared reflected images.

According to the above-mentioned conventional method, the imaging device must correctly recognize an infrared light emitting time point and an infrared off time point to extract reflected images. However, it may be difficult for a general imaging device to extract high-speed images and to correctly perform image capture at the infrared light emitting time point. Accordingly, additional hardware configurations may be required to implement necessary technologies.

### SUMMARY

Therefore, the present invention provides an apparatus and method for detecting a short-range object, which emit modulated infrared light to the object, observe the emitted infrared light, and detect an object located within a relatively short range, and a vehicle using the same. Additional aspects of the invention will be set forth in part in the description which follows and, in part, will be obvious from the description, or may be learned by practice of the invention.

In accordance with an aspect of the present invention, an apparatus for detecting a short-range object may include: a light transmitter configured to emit brightness-modulated light to an object; a light receiver configured to acquire a plurality of reflected image frames reflected from the object; and a processor configured to extract a short-range object by analyzing brightness change of at least one of the plurality of reflected image frames.

The processor may be configured to analyze brightness of each pixel of each of the plurality of reflected image frames, and extract an object that corresponds to the pixel in which a brightness change value is greater than a reference value, as the short-range object. The processor may further be configured to analyze brightness of each pixel of each reflected image frame, and extract an object that corresponds to the pixel in which a brightness change period is the same as a brightness modulation period of the modulated light, as the short-range object.

The apparatus may further include: a modulator configured to provide a light brightness modulation period for modulating the brightness change to the light transmitter. The apparatus may further include: a memory configured to store the plurality of reflected image frames based on the order of image acquisition time, and when the number of stored reflected image frames is greater than a predetermined image frame storage reference, and sequentially delete the reflected image frames arranged in the order from the oldest reflected image frame to the latest reflected image frame. The light transmitter may include a plurality of light emitting diodes (LEDs). The light receiver may be a single infrared imaging device. The light transmitter and the light receiver may be incorporated into one module, or are implemented independently from each other.

In accordance with another aspect of the present invention, a method for detecting a short-range object may include: modulating brightness of light; emitting the modulated light to an object; acquiring a plurality of reflected image frames from the object; and extracting a short-range object by analyzing brightness change of at least one of the plurality of reflected image frames.

The extracting of the short-range object may include: analyzing brightness of each pixel of each reflected image frame; upon receiving the analyzed result, determining the presence or absence of a pixel in which a brightness change value between the plurality of reflected image frames is greater than a reference value; and when the presence of the pixel in which the brightness change value is greater than the reference value is determined, extracting an object that corresponds to the pixel, as the short-range object.

The extracting of the short-range object may include: analyzing brightness of each pixel of each reflected image frame; upon receiving the analyzed result, determining the presence or absence of a pixel in which a brightness change period between the plurality of reflected image frames is the same as a modulation period of the light brightness; when the presence of the pixel in which the brightness change period is the same as the light brightness modulation period, extracting an object that corresponds to the pixel, as the short-range object.

The acquiring of the plurality of reflected image frames may include: storing the plurality of acquired reflected image frames based on the order of image acquisition time; and when the number of stored reflected image frames is greater than a predetermined image frame storage reference, sequentially deleting the reflected image frames arranged in the order from the oldest reflected image frame to the latest reflected image frame. The light may be infrared light.

In accordance with another aspect of the present invention, a vehicle include: a light transmitter configured to emit brightness-modulated light to an object; a light receiver configured to acquire a plurality of reflected image frames reflected from the object; and a processor configured to extract a short-range object by analyzing brightness change of at least one of the plurality of reflected image frames.

The processor may be configured to analyze brightness of each pixel of each of the plurality of reflected image frames, and extract an object that corresponds to the pixel in which a brightness change value is greater than a reference value, as the short-range object. The processor may further be configured to analyze brightness of each pixel of each reflected image frame, and extract an object that corresponds to the pixel in which a brightness change period is the same as a brightness modulation period of the modulated light, as the short-range object.

The vehicle may further include: a modulator configured to provide a light brightness modulation period for modulating the brightness change to the light transmitter. The vehicle may further include: a memory configured to store the plurality of reflected image frames based on the order of image acquisition time, and when the number of stored reflected image frames is greater than a predetermined image frame storage reference, and sequentially delete the reflected image frames arranged in the order from the oldest reflected image frame to the latest reflected image frame. The light transmitter may include a plurality of light emitting diodes (LEDs). The light receiver may be installed at any position where an object or hand within the vehicle may be detected. The light receiver may be a single infrared imaging device (e.g., camera, video camera, or the like).

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is a view illustrating the appearance of a vehicle according to an exemplary embodiment of the present invention;

FIG. 2 is a view illustrating the internal structure of the vehicle according to an exemplary embodiment of the present invention;

FIG. 3 is a conceptual diagram illustrating a method for acquiring a reflected image according to an exemplary embodiment of the present invention;

FIG. 4 is a block diagram illustrating an apparatus for detecting a short-range object according to an exemplary embodiment of the present invention;

FIG. 5 is a conceptual diagram illustrating a method for storing a reflected image frame according to an exemplary embodiment of the present invention;

FIG. 6 is a conceptual diagram illustrating a method for detecting a short-range object according to an exemplary embodiment of the present invention;

FIG. 7 is a block diagram illustrating a vehicle for detecting a short-range object according to another exemplary embodiment of the present invention;

FIG. 8 is a view illustrating the internal structure of a vehicle equipped with a short-range object detection apparatus according to an exemplary embodiment of the present invention;

FIG. 9 shows another example showing a vehicle equipped with a short-range object detection apparatus according to another exemplary embodiment of the present invention;

FIG. 10 is a front view illustrating a connection structure between an infrared LED and an infrared imaging device according to an exemplary embodiment of the present invention;

FIG. 11 is a view illustrating a connection structure between an infrared LED and an infrared imaging device according to an exemplary embodiment of the present invention.

FIGS. 12 to 14 are views illustrating the short-range object detection result according to an exemplary embodiment of the present invention;

FIGS. 15 to 17 are views illustrating a difference in brightness according to various distances according to an exemplary embodiment of the present invention;

FIG. 18 is a conceptual diagram illustrating a method for extracting a reflected image according to an exemplary embodiment of the present invention;

FIG. 19 is a flowchart illustrating a method for detecting a short-range object according to an exemplary embodiment of the present invention; and

FIG. 20 is a flowchart illustrating a method for detecting a short-range object according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the above and other objects, specific advantages, and novel features of the present invention will become apparent from the following description of exemplary embodiments, given in conjunction with the accompanying drawings. Reference will now be made in detail to the exemplary embodiments of the present invention, examples of which are illustrated in the accompanying drawings. Wherever possible, the same reference numbers will be used throughout the drawings to refer to the same or like parts. In the following description, known functions or structures, which may confuse the substance of the present invention, are not explained. It will be understood that, although the terms first, second, etc. may be used herein to describe various elements, components, regions, layers and/or sections, these elements, components, regions, layers and/or sections should not be limited by these terms.

An apparatus and method for detecting a short-range object and a vehicle using the same according to embodiments of the present invention will hereinafter be described with reference to the attached drawings.

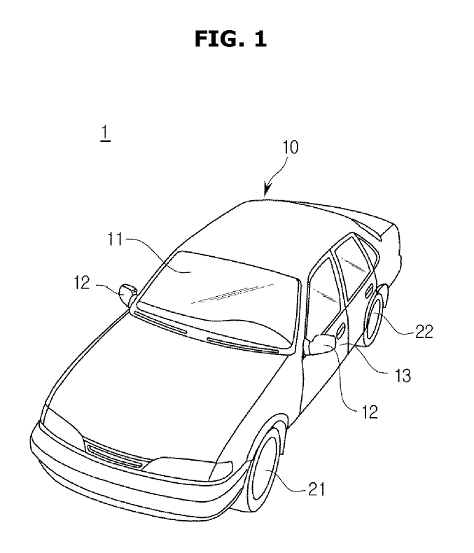

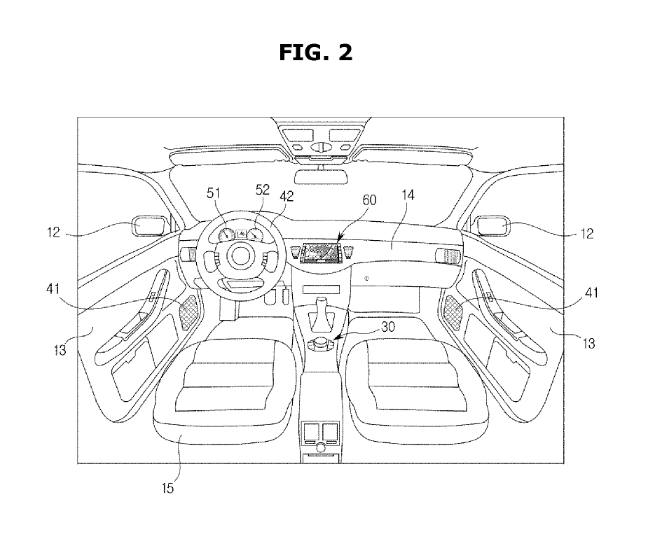

FIG. 1 is a perspective view illustrating the appearance of a vehicle according to an exemplary embodiment of the present invention. FIG. 2 is a view illustrating the internal structure of the vehicle according to an exemplary embodiment of the present invention.

Referring to FIG. 1, the vehicle 1 according to the exemplary embodiment may include a main body 10 forming the appearance of the vehicle 1 (e.g., provides the exterior shape of the vehicle); a vehicle windshield 11 that provides a forward view of the vehicle 1; side-view mirrors 12 that provide a rear view of the vehicle 1; doors 13 that shield an indoor space of the vehicle 1 from the exterior; and a plurality of wheels (21, 22) including front wheels 21 disposed at the front of the vehicle and rear wheels 22 disposed at the rear of the vehicle.

The windshield 11 may be disposed at a front upper portion of the main body 10 to provide access to visual information of a forward direction of the vehicle 1. The windshield 11 may also be referred to as a windshield glass or a windscreen. The side-view mirrors 12 may include a left side-view mirror disposed at the left of the main body 10 and a right side-view mirror disposed at the right of the main body 10 to provide visual information of the lateral and rear directions of the vehicle 1. The doors 13 may be rotatably attached at the right and left sides of the main body 10.

Referring to FIG. 2, the interior structure of the vehicle 1 may include a dashboard 14 having a plurality of electronic components used to manipulate the vehicle 1; a driver seat 15; cluster display units (51, 52) configured to display operation information of the vehicle 1; an Audio Video Navigation (AVN) device 60 configured to provide navigation information and audio/video (AV) functions upon receiving a command from the vehicle driver.

In particular, the dashboard 14 may protrude from a lower part of the windshield 11 toward the vehicle driver, allowing a driver to look forward while manipulating various devices mounted to the dashboard 14 using the dashboard 14. The driver seat 15 may be disposed at the rear of the dashboard to allow the driver to view various devices of the dashboard 14 while driving. The cluster display units (51, 52) disposed adjacent to the driver seat 15 of the dashboard 14 may include a speed gauge 51 configured to display a traveling speed of the vehicle 1, and a revolutions per minute (RPM) gauge 52 configured to display a rotation speed of a power system (not shown).

The AVN device 60 may include a display configured to output a navigation function to provide information regarding a road on which the vehicle 1 travels or a route toward a destination desired by the vehicle driver; and a speaker 41 configured to output sound based on a driver command. The AVN device 60 may have a navigation function, an audio function, and a video function.

The vehicle 1 may further include a power system (not shown) configured to rotate wheels (21, 22); a steering system (not shown) used to steer the vehicle 1; and a brake system (not shown) configured to stop movement of the wheels (21, 22). The power system may provide rotational force to the front wheels 21 or the rear wheels 22 to move the main body 10 forward or backward. Additionally, the power system may include an engine configured to generate rotational force by burning fossil fuels or a motor configured to generate rotational force upon receiving a power source from a condenser (not shown).

The steering system may include a steering wheel 42 configured to receive a travel direction from the vehicle driver; a steering gear (not shown) configured to convert the rotary motion of the steering wheel 42 into the reciprocating motion; and a steering link (not shown) configured to deliver the reciprocating motion of the steering gear (not shown) to the front wheels 21. The steering system may change the direction of each rotation axis of the wheels (21, 22), to allow the vehicle 1 to be steered. The brake system may include a brake pedal (not shown) configured to receive braking manipulation from the vehicle driver; a brake drum (not shown) coupled to the wheels (21, 22); and a brake shoe (not shown) configured to brake rotation of the brake drum (not shown) using frictional force. The brake system may be configured to stop rotation of the wheels (21, 22), to brake the vehicle 1 while it is being driven.

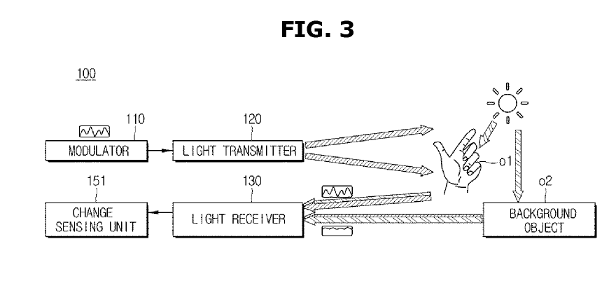

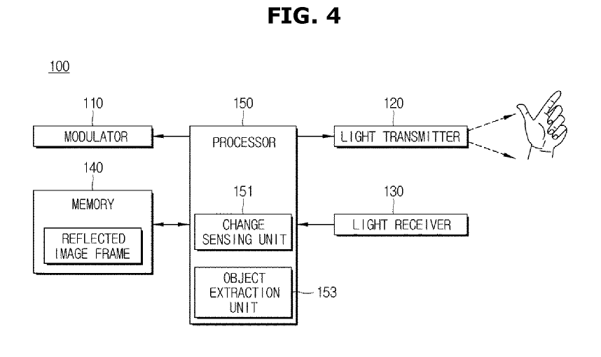

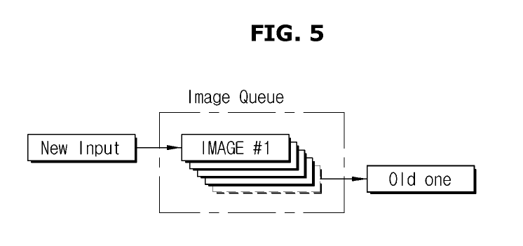

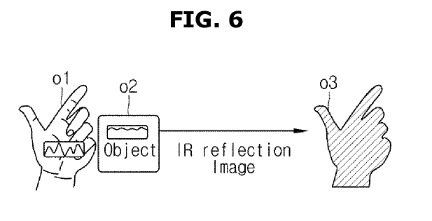

FIG. 3 is a conceptual diagram illustrating a method for acquiring a reflected image according to an exemplary embodiment of the present invention. FIG. 4 is a block diagram illustrating an apparatus for detecting a short-range object according to an exemplary embodiment of the present invention. FIG. 5 is a conceptual diagram illustrating a method for storing a reflected image frame. FIG. 6 is a conceptual diagram illustrating a method for detecting a short-range object.

Referring to FIGS. 3 and 4, the short-range object detection apparatus 100 may include a modulator 110, a light transmitter 120, a light receiver 130, a memory 140, and a processor 150. The modulator 110 may be configured provide a light brightness modulation period for changing light brightness to the light transmitter 120. In particular, the light brightness modulation period may include a pattern not generated in the natural environment, a pattern in which no interference occurs due to the peripheral environment, or a pattern different from other patterns having periodicity under the peripheral environment, such that the pattern corresponding to the light brightness modulation period may artificially change brightness to distinguish the pattern from a pattern of light (e.g., natural light, etc.) causing interference.

The light transmitter 120 may be configured to emit brightness-modulated light to the objects (O1 and O2 of FIG. 3). In particular, the light transmitter 120 may be configured to change brightness using voltage regulation of a modulation circuit. Although the brightness change may be performed at about 100 Hz as an example, the scope of the present invention is not limited thereto. The light transmitter 120 may include a plurality of infrared LEDs. The infrared LEDs may arbitrarily modulate brightness of a light source, such that the light source is modulated to have a greater amplitude and a shorter change period than an external light source (e.g., natural light such as sunlight), and the modulated light source may be distinguished from the external light source.

The light receiver 130 may be configured to acquire a plurality of reflected image frames reflected from the object. In particular, the light receiver 130 may be a single infrared (IR) imaging device (e.g., camera, video camera, or the like), and may include a visible light cut-off filter. The light receiver 130 may be configured to acquire image frames reflected from the environment to which the modulated light is emitted, using the light transmitter 120. The light transmitter 120 and the light receiver 130 may be integrated with each other in one body, or may be implemented separately from each other.

The memory 140 may be configured to store the plurality of reflected image frames according to the order of image frame acquisition. When the number of stored reflected image frames is greater than a predetermined number of stored image frames, the oldest reflected image frame from among the stored reflected image frames may be first deleted and the latest reflected image frame may be finally deleted, to sequentially delete the stored reflected image frames arranged in the order from the oldest reflected image frame to the latest reflected image frame. In particular, the memory 140 may be formed in a queue shape configured to store a predetermined number of frames. When the above-mentioned light transmitter 120 is implemented as an IR imaging device, the memory 140 may be independently implemented, or may be implemented in the IR imaging device, as shown in FIG. 4.

Referring to FIG. 5, under the condition that a plurality of reflected image frames (Image #1, Image #2˜Image #N) is stored in the memory 140, when the number of reflected image frames is greater than a predetermined number of reflected image frames indicating a predetermined image frame storage reference, and when a new reflected image frame is stored (See “New Input” of FIG. 5), the oldest reflected image (See “Old One” of FIG. 5) from among the stored reflected image frames may first be deleted from the memory 140.

Furthermore, the processor 150 may be configured to extract a short-range object by analyzing a brightness change of at least one of the plurality of reflected image frames. For this purpose, the processor 150 may include a change sensing unit 151 (e.g., a sensor) configured to analyze the brightness change based on the plurality of reflected image frames; and an object extraction unit 153 configured to extract a short-range object using the analyzed brightness change. In other words, the processor 150 may be configured to analyze the brightness change of at least one object contained in each reflected image frame acquired using the light receiver 130, to extract the short-range object.

Referring to FIG. 6, after the light transmitter 120 emits light to the objects (O1 and O2 of FIG. 6), the light transmitter 120 may be configured to acquire reflected image frames using the light receiver 130, analyze the brightness change of the reflected image frames, and extract the short-range object 03 based on the analysis result. The following two methods may be used to extract the short-range object 03.

Particularly, the processor 150 may be configured to analyze brightness of the respective reflected image frames to extract the corresponding object of a pixel in which a brightness change is greater than a reference value, as a short-range object. In addition, the processor 150 may be configured to analyze brightness of each pixel of the plurality of reflected image frames, and extract the corresponding object of the pixel in which a period of brightness change is about the same as a brightness modulation period of the modulated light, as a short-range object.

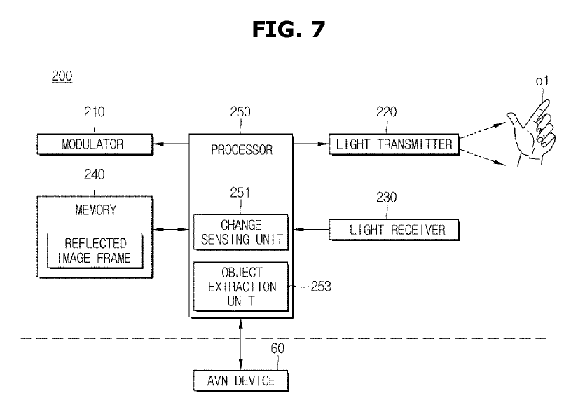

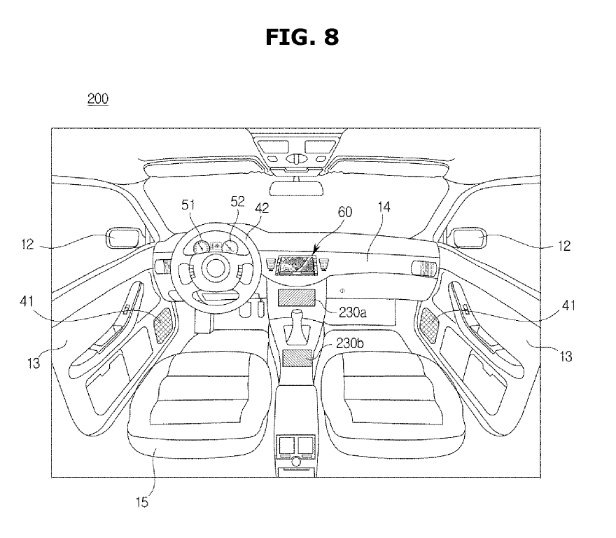

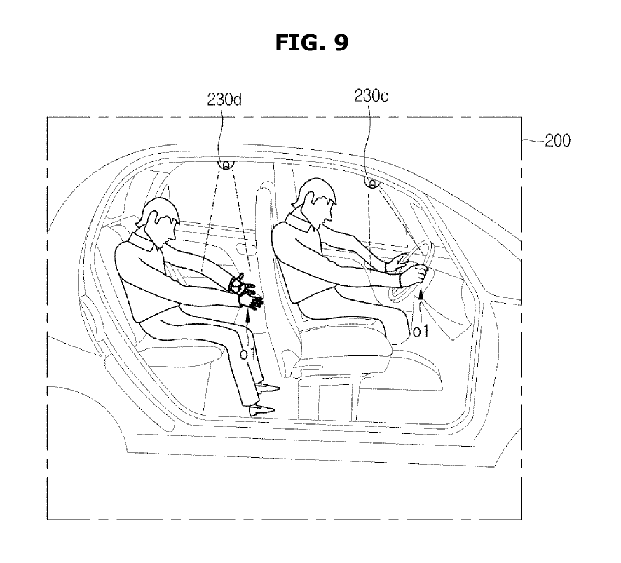

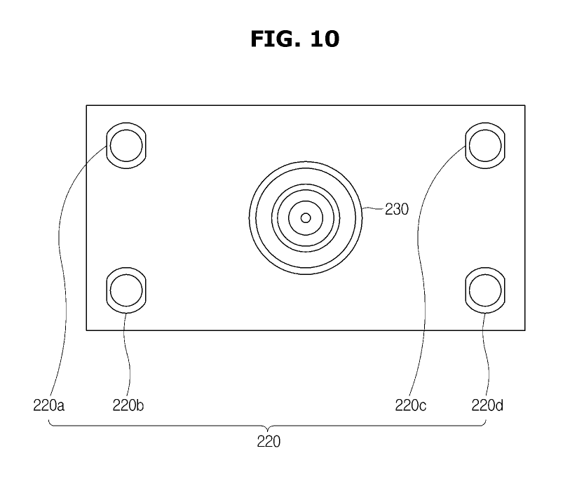

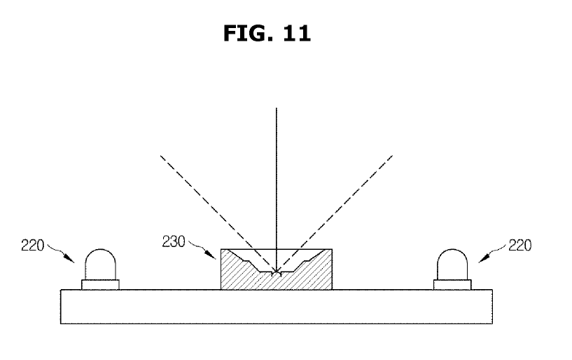

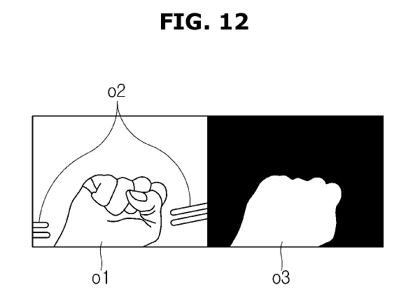

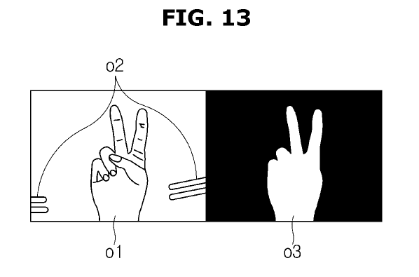

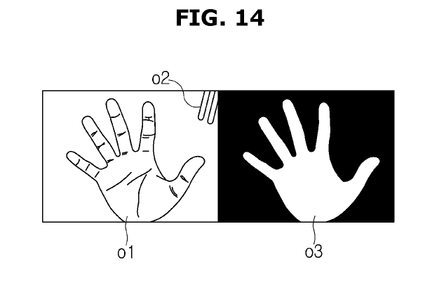

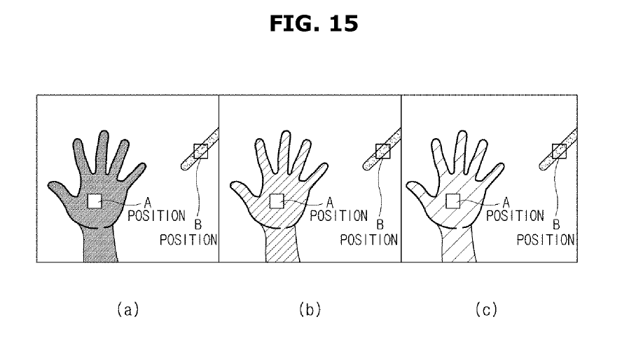

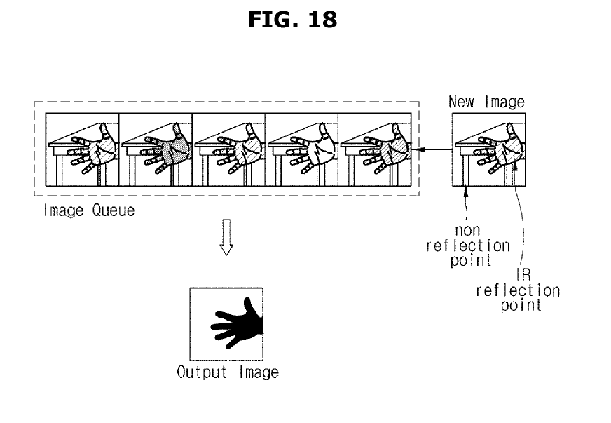

FIG. 7 is a block diagram illustrating a vehicle for detecting a short-range object according to another exemplary embodiment of the present invention. FIG. 8 is a view illustrating the internal structure of a vehicle equipped with a short-range object detection apparatus according to an exemplary embodiment of the present invention. FIG. 9 shows another example showing a vehicle equipped with a short-range object detection apparatus according to another exemplary embodiment of the present invention. FIG. 10 is a front view illustrating a connection structure between an infrared LED and an infrared imaging device. FIG. 11 is a plan view illustrating a connection structure between an infrared LED and an infrared imaging device. FIGS. 12 to 14 are views illustrating examples of the short-range object detection result. FIGS. 15 to 17 are views illustrating a difference in brightness according to various distances. FIG. 18 is a conceptual diagram illustrating a method for extracting a reflected image.

Referring to FIG. 7, the vehicle 200 may include a modulator 210, a light transmitter 220, a light receiver 230, a memory 240, and a processor 250. In particular, the vehicle 200 may include an AVN device 60 coupled to the processor 250 wherein the AVN device 60 may be configured to provide various services to the vehicle 200.

Further, the modulator 210 may be configured to provide the light brightness modulation period for changing light brightness to the light transmitter 220. The light transmitter 220 may be configured to emit brightness-modulated light to the object. For example, the light transmitter 220 may be configured to emit the modulated light to object or hand (e.g., driver hand, finger, or the like) within the vehicle 200. For this purpose, the light transmitter 220 may be mounted to any position where light may easily arrive at the hands of the driver.

Particularly, the modulated light emitted through the light transmitter 220 may reach various internal devices located in the vicinity of the hands. When using a technology for analyzing a driver hand gesture to operate or drive various services embedded within the vehicle, the light transmitter 220 may be disposed closer to (e.g., proximate to or within a particular distance to) the driver hand instead of various devices embedded within the vehicle. In addition, the light transmitter 220 may include a plurality of infrared LEDs.

The light receiver 230 may be configured to acquire a plurality of reflected image frames reflected from the object. In particular, the light receiver 230 may be a single IR imaging device, and may include a visible light cut-off filter. The scope of the light receiver 230 is not limited to the single IR imaging device, and it should be noted that the light receiver 230 may also be replaced with other imaging devices as necessary without departing from the scope or spirit of the present invention.

In addition, the light receiver 230 may be installed at any position where any hand of the user within the vehicle may be detected. For example, as seen from FIG. 8, the light receiver 230 may be installed at the positions (230a, 230b) of a center fascia (or center console) where the hands of the user may be recognized. The center fascia may be a control panel, disposed between the driver seat and the passenger seat, in the dashboard 14. The dashboard 14 and a shift lever may be perpendicular to each other at the center fascia. The center fascia region may include the AVN device 60, a controller for an audio, air-conditioner, and heater, an air vent (i.e., an air outlet), a cigar jack, an ashtray, a cup holder, etc. The center fascia may include a center console to physically provide a separate between the driver seat and the passenger seat.

As shown in FIG. 9, the light receiver 230 may be installed to the ceiling positions of front seats including the driver seat and the passenger seat, and also to the ceiling positions (230c, 230d) of back seats of the vehicle 200 to allow the light receiver 230 to recognize the hand O1 of the users who seat on the front and back seats of the vehicle 200. However, the scope or spirit of the present invention is not limited thereto, and may also be applied to other examples without difficulty.

Referring to FIGS. 10 and 11, the light transmitters (220a, 220b, 220c, 220d) and the light receiver 230 may be incorporated with each other, without being limited thereto. When necessary, the light transmitter (220a, 220b, 220c, or 220d) and the light receiver 230 may also be implemented independently of each other. Referring to FIG. 11, when the light transmitter 220 emits light to the object, the light receiver 230 may be configured to acquire reflected image frames reflected from the object.

The memory 240 may sequentially store the plurality of reflected image frames according to the order of image frame acquisition. When the number of stored reflected image frames is greater than a predetermined number of stored image frames, the oldest reflected image frame from among the stored reflected image frames may be first deleted and the latest reflected image frame may be deleted last, to sequentially delete the stored reflected image frames arranged in the order from the oldest reflected image frame to the latest reflected image frame. In addition, the memory 240 may be configured to store the latest reflected image frames. A short-range object (e.g., user's hands or other object) may be extracted about every second, and the extraction may be performed in parallel in the subsequent algorithm processing, such that a predetermined number of frames may be observed based on a particular time.

Furthermore, the processor 250 may be configured to analyze a brightness change of at least one of the plurality of reflected image frames to extract a short-range object based on the analyzed result. In other words, the processor 250 may be configured to analyze a brightness change of at least one object contained in each reflected image frame acquired using the light receiver 230, to extract the short-range object based on the analyzed result. For this purpose, the processor 250 may include a change sensing unit 251 configured to analyze a brightness change from the plurality of reflected image frames; and an object extraction unit 253 configured to extract a short-range object through the analyzed brightness change.

Referring to FIGS. 12 to 14, the processor 250 may be configured to extract the hand (O1) from among the hand (O1) and the background object (O2) (see the left drawings of FIGS. 12 to 14) in the reflected image frames, as the short-range object (O3) (see the right drawings of FIGS. 12 to 14). In particular, the processor 250 may be configured to analyze brightness of each pixel of the plurality of reflected image frames, and extract an object that corresponds to the pixel in which the brightness change is greater than a reference value, as the short-range object (thus differentiating from other objects within the vehicle, such as background objects).

In addition, the processor 250 may be configured to analyze brightness of each pixel of each reflected image frame, and extract an object that corresponds to the pixel in which a period of the brightness change is about that same as a brightness modulation period of the modulated light, as the short-range object. For example, FIGS. 15 to 17 illustrate that brightness of the infrared LED is modulated in the form of sine waves through the light transmitter 220 such that the modulated light is emitted to the object. The processor 250 may be configured to acquire a plurality of reflected image frames (FIGS. 15(a), 15(b), and 15(c)) indicating the brightness change between the A-position object and the B-position object using the light receiver 230. In FIG. 15, the A position may be spaced apart from the light receiver 230 by a predetermined distance of about 30 cm, and the B position may be spaced apart from the light receiver 230 by a predetermined distance of about 2.50 m.

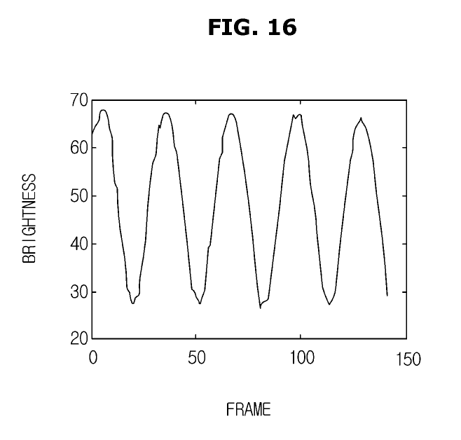

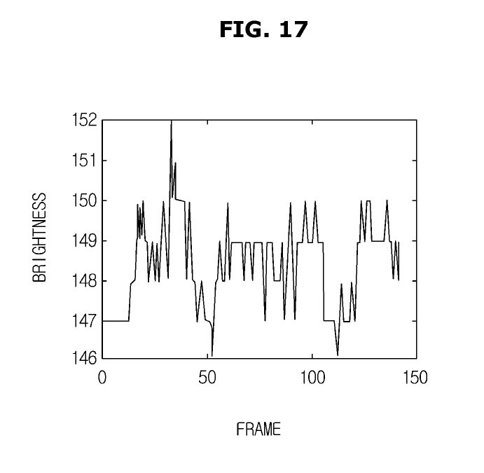

As shown in FIG. 16, the brightness change of the A-position object changes significantly in the form of high-amplitude sine waves in a similar way to sine waves indicating the brightness change of the infrared LED. In contrast, as shown in FIG. 17, the brightness change of the B-position object is changed less than the brightness change of the A-position object. The object located at the B position is therefore more affected by natural light than light artificially emitted from the light transmitter 220, such that the B-position object is spaced apart from the light transmitter 220 (e.g., the infrared LED) by a substantial distance whereas the B-position object has high brightness. As a result, brightness change caused by the modulated light emitted from the light transmitter 220 may be minimal.

Compared to the concept of FIG. 15 in which brightness change of the infrared LED is successively performed, FIG. 18 illustrates that brightness change of the infrared LED through the light transmitter 220 is modulated in a zigzag pattern having high amplitude and then emitted to the object. In particular, the processor 250 may be configured to acquire a plurality of reflected image frames shown in FIG. 18 using the light receiver 230. The level of brightness change between the reflected image frames is greater than that of FIG. 15, and thus a short-range object may be extracted using a smaller number of reflected image frames.

As shown in FIG. 18, brightness change of the user's hand located within a shorter range than in the light transmitter 220 and a desk is more clearly shown in reflected image frames acquired according to light brightness modulation. In contrast, brightness change of the desk indicating a background object is shown to be minimal.

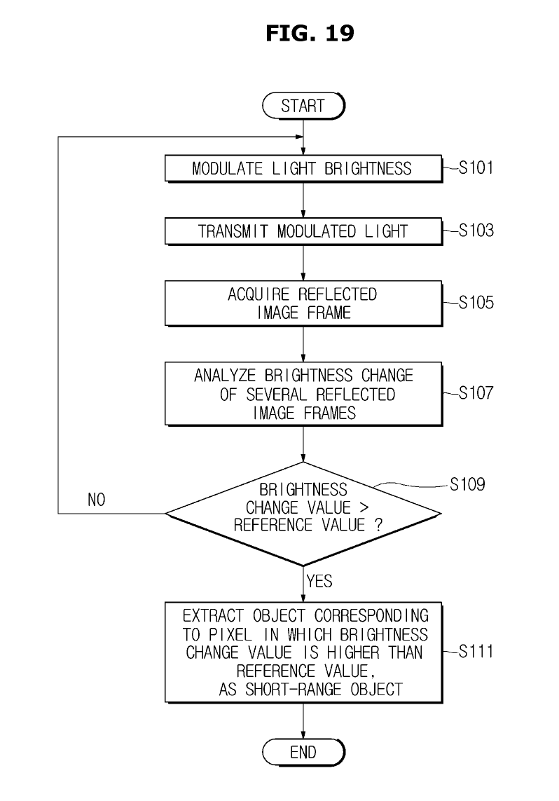

FIG. 19 is a flowchart illustrating a method for detecting a short-range object according to an exemplary embodiment of the present invention. Referring to FIG. 19, the short-range object detection apparatus 100 may modulate brightness of light in operation S101. Here, the light may be infrared light.

The short-range object detection apparatus 100 may be configured to emit the modulated light to the object in operation S103. The short-range object detection apparatus 100 may further be configured to acquire a plurality of reflected image frames reflected from the object in operation S105. In particular, the short-range object detection apparatus 100 may be configured to store the plurality of acquired reflected image frames according to the order of image acquisition time.

In addition, when the number of stored reflected image frames is greater than a predetermined number of reflected image frames indicating a predetermined image frame storage reference, the oldest stored reflected image frame from among the stored reflected image frames may be deleted first and the latest stored reflected image frame may be deleted last to sequentially delete the stored reflected image frames according to the order of image frame storage time.

Thereafter, the short-range object detection apparatus 100 may be configured to analyze brightness change of at least one of the plurality of reflected image frames to extract a short-range object in operations (S107˜S111). In particular, the short-range object detection apparatus 100 may be configured to analyze brightness of each pixel of the plurality of reflected image frames in operation S107.

Through the analyzed result, it may be recognized whether there is a pixel in which a brightness change value between the reflected image frames is greater than a reference value in operation S109. When the brightness change value of a pixel is greater than the reference value in operation S109, an object that corresponds to the pixel may be extracted as a short-range object in operation S111. When the brightness change value is equal to or less than the reference value in operation S109, the short-range object detection apparatus 100 may be configured to re-perform the above operations starting from the operation S101.

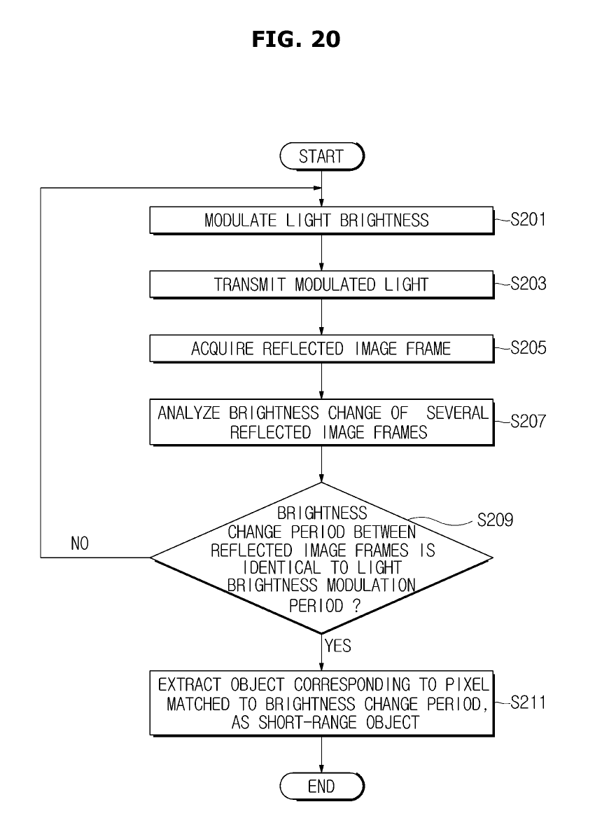

FIG. 20 is a flowchart illustrating a method for detecting a short-range object according to another exemplary embodiment of the present invention. Referring to FIG. 20, the short-range object detection apparatus 100 may modulate brightness of light in operation S201. Here, the light may be infrared light.

The short-range object detection apparatus 100 may be configured to emit the modulated light to the object in operation S203. The short-range object detection apparatus 100 may further be configured to acquire a plurality of reflected image frames reflected from the object in operation S205. In particular, the short-range object detection apparatus 100 may be configured to store the plurality of acquired reflected image frames according to the order of image acquisition time.

In addition, when the number of stored reflected image frames is greater than a predetermined number of reflected image frames indicating a predetermined image frame storage reference, the oldest stored reflected image frame from among the stored reflected image frames may be deleted first and the latest stored reflected image frame may be deleted last to sequentially delete the stored reflected image frames arranged in the order from the oldest reflected image frame to the latest reflected image frame.

Thereafter, the short-range object detection apparatus 100 may be configured to analyze brightness change of at least one of the plurality of reflected image frames to extract a short-range object in operations (S207˜S211). In particular, the short-range object detection apparatus 100 may be configured to analyze brightness of each pixel of the plurality of reflected image frames in operation S207.

Through the analyzed result, whether a pixel in which a brightness change period between the reflected image frames is equal to the light brightness modulation period may be determined in operation S209. When the brightness change period of the pixel is equal to the light brightness modulation period in operation S209, an object that corresponds to the pixel may be extracted as a short-range object in operation S211. When the brightness change period of the pixel is not equal to the light brightness modulation period in operation S209, the short-range object detection apparatus 100 may be configured to re-perform the above operations starting from the operation S201.

As is apparent from the above description, the exemplary embodiments of the present invention use a brightness variation of a reflected image frame while simultaneously modulating an infrared LED at a high speed, and extract a short-range object having a minimum influence affected by external light source, such that reliability of the short-range object detection result may be improved. In addition, the exemplary embodiments of the present invention may use a single imaging device to detect or capture an object located adjacent to the imaging device.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An apparatus for detecting a short-range object, comprising:
a light transmitter configured to emit brightness-modulated light to an object;
a light receiver configured to acquire a plurality of reflected image frames reflected from the object; and
a processor configured to extract the short-range object by analyzing brightness change of at least one of the plurality of reflected image frames.

2. The apparatus according to claim 1, wherein the processor is configured to analyze brightness of each pixel of each reflected image frame, and extract an object that corresponds to the pixel in which a brightness change value is greater than a reference value, as the short-range object.

3. The apparatus according to claim 1, wherein the processor is configured to analyze brightness of each pixel of each reflected image frame, and extract an object that corresponds to the pixel in which a brightness change period is the same as a brightness modulation period of the modulated light, as the short-range object.

4. The apparatus according to claim 1, further comprising:
a modulator configured to provide a light brightness modulation period for modulating the brightness change to the light transmitter.

5. The apparatus according to claim 1, further comprising:
a memory configured to store the plurality of reflected image frames according to the order of image acquisition time, and when the number of stored reflected image frames is greater than a predetermined image frame storage reference, and sequentially delete the reflected image frames arranged in the order from the oldest reflected image frame to the latest reflected image frame.

6. The apparatus according to claim 1, wherein the light transmitter includes a plurality of light emitting diodes (LEDs).

7. The apparatus according to claim 1, wherein the light receiver is a single infrared imaging device.

8. The apparatus according to claim 1, wherein the light transmitter and the light receiver are incorporated into one module, or are implemented independently from each other.

9. A method for detecting a short-range object, comprising:
modulating, by a modulator, brightness of light;
emitting, by a light transmitter, the modulated light to an object;
acquiring, by a light receiver, a plurality of reflected image frames from the object; and
extracting, by a processor, a short-range object by analyzing brightness change of at least one of the plurality of reflected image frames.

10. The method according to claim 9, wherein the extracting of the short-range object includes:
analyzing, by the processor, brightness of each pixel of each reflected image frame;
determining, by the processor, whether a brightness change value between the plurality of reflected image frames of a pixel is greater than a reference value; and
when the brightness change value of the pixel is greater than the reference value, extracting, by the processor, an object that corresponds to the pixel, as the short-range object.

11. The method according to claim 9, wherein the extracting of the short-range object includes:
analyzing, by the processor, brightness of each pixel of each of the plurality of reflected image frames;
determining, by the processor, whether a brightness change period between the plurality of reflected image frames of a pixel is the same as a modulation period of the light brightness;
when the brightness change period of the pixel is the same as the light brightness modulation period, extracting, by the processor, an object that corresponds to the pixel, as the short-range object.

12. The method according to claim 9, wherein the acquiring of the plurality of reflected image frames includes:
storing, by the processor, the plurality of acquired reflected image frames according to the order of image acquisition time; and
when the number of stored reflected image frames is greater than a predetermined image frame storage reference, sequentially deleting the reflected image frames arranged in the order from the oldest reflected image frame to the latest reflected image frame.

13. The method according to claim 9, wherein the light is infrared light.

14. A vehicle, comprising:
a light transmitter configured to emit brightness-modulated light to an object;
a light receiver configured to acquire a plurality of reflected image frames reflected from the object; and
a processor configured to extract a short-range object by analyzing brightness change of at least one of the plurality of reflected image frames.

15. The vehicle according to claim 14, wherein the processor is configured to analyze brightness of each pixel of each reflected image frame, and extract an object that corresponds to the pixel in which a brightness change value is greater than a reference value, as the short-range object.

16. The vehicle according to claim 14, wherein the processor is configured to analyze brightness of each pixel of each reflected image frame, and extract an object that corresponds to the pixel in which a brightness change period is the same as a brightness modulation period of the modulated light, as the short-range object.

17. The vehicle according to claim 14, further comprising:
a modulator configured to provide a light brightness modulation period for modulating the brightness change to the light transmitter.

18. The vehicle according to claim 14, further comprising:
a memory configured to store the plurality of reflected image frames according to the order of image acquisition time, and when the number of stored reflected image frames is greater than a predetermined image frame storage reference, and sequentially delete the reflected image frames arranged in the order from the oldest reflected image frame to the latest reflected image frame.

19. The vehicle according to claim 14, wherein the light transmitter includes a plurality of light emitting diodes (LEDs).

20. The vehicle according to claim 14, wherein the light receiver is installed at any position where an object within the vehicle is detectable.

21. The vehicle according to claim 14, wherein the light receiver is a single infrared imaging device.
